(19) United States
(12) Patent Application Publication
(10) Pub. No.: US 2006/0194910 A1
(43) Pub. Date: Aug. 31, 2006

(54) Stabilization of polymers with zinc oxide nanoparticles

(76) Inventors: Nobuo Miyatake, Houston, TX (US); Hung-Jue Sue, College Station, TX (US); Yuntao Li, College Station, TX (US); Katsumi Yamaguchi, Hyogo (JP)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/312,043

(22) Filed: Dec. 20, 2005

Related U.S. Application Data
(63) Continuation-in-part of application No. 10/848,882, filed on May 19, 2004.

(51) Int. Cl. C08K 3/22

(52) U.S. Cl. 524/432

(57) ABSTRACT

A composition and method of making a stabilizer for polymers. The composition has zinc oxide (ZnO) nanoparticles dispersed and having an average size of no more than about 15 nanometers, wherein the ZnO nanoparticles are provided as an additive to a polymeric material, thereby forming a stabilized polymer composite in which the ZnO nanoparticles remain dispersed and have an average size of no more than about 15 nanometers. The stabilized polymer composite is stabilized against heat and ultraviolet light. The polymeric material can be a (meth)acrylic resin, a styrenic resin, a pre-cure epoxy resin, or combinations thereof. In a concentrated form, the composition has ZnO nanoparticles that are typically less than 20% of the stabilized polymer composite. The stabilizer is polymerizable and may include additional additives.

### CROSS-REFERENCES TO RELATED APPLICATIONS

This application is a continuation-in-part of prior U.S. application Ser. No. 10/848,882 filed May 19, 2004, herein incorporated by reference.

### STATEMENT REGARDING FEDERALLY SPONSORED APPLICATIONS

Not applicable.

### REFERENCE TO A “SEQUENCE LISTING”

Not applicable.

### BACKGROUND OF THE INVENTION

1. Field of the Invention

This invention relates to improved stabilizing effects on polymers, and in particular, stabilizing effects provided by nanocomposites for protection of polymers.

2. Description of the Related Art

Polymer stability is an important factor relating to the usefulness of a given polymer. Unfortunately, most polymers degrade over time as a result of environmental elements, such as oxidation, heat, and light. Several methods to reduce polymer degradation and hence improve polymer stability have relied on the inclusion of additives and/or fillers, such as thermal stabilizers or UV stabilizers in order to reduce degradation. Unfortunately, no single additive or filler is yet able to adequately stabilize polymers, nor is any single additive or filler capable of preventing degradation from more than one environmental element. A stabilizer for polymers that is provided as a simple additive or filler and able to prevent degradation from more than one environmental element would be extremely beneficial for the polymer industry.

It is well known that zinc oxide (ZnO) particles are safe materials with UV absorption capabilities. ZnO particles have been used as an UV absorber in sunscreen and cosmetic applications. It has also been reported that ZnO particles could be used as a UV stabilizer for polyolefins (e.g., J. Nanoparticle Research 2002;4:167-174). If ZnO particles were to provide thermal stability, it would be a great material for prevention of both thermal degradation and UV degradation.

ZnO particles having an average particle size of 38 nm to 63 nm have been blended with polyethylene (e.g., J. Mater. Res. 2002;17:940-943 and Polym. Eng. Sci. 2004;44:1702-1706). Thermal stability was improved only when the amount of ZnO particles in polyethylene was greater than 5-10% by weight. The method required a significant amount of ZnO particles to provide the final product; such an amount is unacceptable for practical uses. ZnO particles with an average particle size of 20 nm have been blended with polyacrylate (e.g., Polym. Degrad. Stab., 2005:87;103-110). ZnO particles were added to polyacrylate at concentrations of 14.3% by weight without providing any improvements in thermal stability as compared with a mixture of polyacrylate and conventional micron size ZnO. To date, ZnO particles have not been found to improve thermal stability of a polymer.

### BRIEF SUMMARY OF THE INVENTION

In one form, the present invention provides for a stabilizer composition for polymers comprising ZnO nanoparticles dispersed and having an average size of no more than about 15 nanometers, wherein the ZnO nanoparticles are provided as an additive to a polymeric material, thereby forming a stabilized polymer composite in which the ZnO nanoparticles remain dispersed and have an average size of no more than about 15 nanometers. The average size range is from at least about 1 to less than 20 nanometers. The average particle size of ZnO nanoparticles have a standard deviation of about 3 nanometers.

In another form, the present invention provides for a stabilizer composition for polymers comprising ZnO nanoparticles dispersed and having an average size of no more than about 15 nanometers and a polymeric material comprising a (meth)acrylic resin, a styrenic resin, a pre-cure epoxy resin, and combinations thereof, combined with the ZnO nanoparticles to form a stabilized polymer composite, wherein the ZnO nanoparticles remain dispersed and have an average size of no more than about 15 nanometers. The average size range is from 1 to 15 nanometers. The average particle size of ZnO nanoparticles have a standard deviation of about 3 nanometers.

In yet another form, the present invention provides for dispersing ZnO nanoparticles having an average size of no more than about 15 nanometers in a polymeric material comprising (meth)acrylic unit, a styrenic unit, a pre-cure epoxy resin, and combinations thereof, thereby forming a stabilized polymer composite, wherein the ZnO nanoparticles remain dispersed and have an average size of no more than about 15 nanometers.

### BRIEF DESCRIPTION OF THE DRAWINGS

Not applicable.

### DETAILED DESCRIPTION OF THE INVENTION

The present invention provides a stabilizer for polymers and a stabilized polymer composite. The stabilizer for polymers is in the form of a ZnO nanoparticle that, when combined with a desired monomer, polymer or copolymer, provides a stabilized polymer composite with superior thermal stability. The nanoparticles have an average diameter 15 nanometers or less, are capable of absorbing ultraviolet (UV) light and act as stabilizers of UV light. The standard deviation of the average particle size is about 3 nanometers.

For improved stability, ZnO nanoparticles of the present invention, were provided as dispersed ZnO nanoparticles having an average particle size of 15 nm or less. ZnO nanoparticles were prepared by methods described in U.S. application Ser. No. 10/848,882. While alternative methods are equally suitable, the methods described herein are particularly suited to provide ZnO nanoparticles of the present invention.

In brief, a zinc oxide precursor was added to an alcohol-based solution to form a reaction mixture. An alcohol-based solution generally comprises a C₁-C₆ alcohol. Such alcohols include, but are not limited to, methanol, ethanol, n-propanol, isopropanol, and combinations thereof. Typically, a basic species is dissolved in an alcohol (i.e., solvent). A basic species is one that is a source of hydroxyl ions, including any species that provides for an alcohol-based solution and reaction mixture pH of at least about 7.0. Basic species include, but are not limited to, lithium hydroxide (LiOH), sodium hydroxide (NaOH), potassium hydroxide (KOH), ammonium hydroxide (NH₄OH), hydrates and combinations thereof. Such basic species are typically dissolved in the alcohol-based solution in a molar concentration generally between about 0.002M and about 2.0M. Additional components may also be included in the alcohol-based solution, such as water and organic species (e.g., acetone, methylethyl ketone, tetrahydrofuran, benzene, toluene, o-xylene, m-xylene, p-xylene, mesitylene, diethyl ether, dichloromethane, chloroform, and combinations thereof). Apart from the alcohol, the basic species and/or any additional (optional) components may comprise as much as about 50 weight percent of the resulting alcohol-based solution, but typically less than 30 weight percent.

The zinc oxide precursor may be added to the alcohol-based solution as a powder. For example, the zinc oxide precursor may first be dissolved in an alcohol or other solvent, then added to the alcohol-based solvent of the present invention. Such additions may occur within a range of addition rates and within a range of temperatures suitable for such addition, and may involve stirring or another suitable agitation process. When suitable, one or more particular atmospheric conditions may be used, e.g., a nitrogen blanket or some other type of inert atmospheric environment. Typically in a reaction mixture, the molar ratio of zinc oxide precursor species to basic species is between about 1:1 and about 1:3.

The reaction mixture for forming ZnO nanoparticles were maintained in conditions typically involving a reaction temperature, a reaction duration, an agitation means, and, optionally, an inert reaction atmosphere. According to the present invention, reaction temperatures generally ranged from at least about 0° C. to at most about 100° C. Reaction durations ranged from about a few seconds to about a few days. Agitation methods included, but were not limited to, stirring, shaking, sonicating, vibrating, and combinations thereof. In some embodiments of the present invention, one or more dopant species were added to a reaction mixture such that doped ZnO nanoparticles were formed. Dopant species were used to modulate the electrical and/or optical properties of the resulting nanosized zinc oxide particles. Suitable dopant species include, but are not limited to, Cu, nickel (Ni), iridium (Ir), and combinations thereof. Doped nanosized ZnO particles, made by a different process, have been described previously (see, e.g., Agne et al., Appl. Phys. Lett., 2003;83:1204-1206).

The method described herein provides for ZnO nanoparticles that may be quantum confined. According to some embodiments of the present invention, ZnO nanoparticles were stored as a colloidal suspension or sol-often at temperatures that preclude their agglomeration. As an alternative, the volatile solvent was removed and the ZnO nanoparticles were stored as a gel.

In one embodiment, a ZnO sol was prepared by adding a precursor of ZnO into an alcohol solution of pH 7.0 or greater and subsequently reacting (e.g., heating, refluxing) this solution at about 50 to 80° C. Such a method of preparing nanoparticles of the present invention enables control of particle size. A typical example in more details includes the preparation of 50 mL of 0.04 M KOH in methanol (alcohol-based solution) by heat at 60° C. with stirring. To this alcohol-based solution was subsequently added 0.22 g (1 mmol) of Zn(OAc)₂.2H₂O (zinc acetate dihydrate) powder under reflux and stirring. Here, the reaction stoichiometry of the zinc acetate dehydrate to KOH was 1:2 (0.02 M:0.04 M). The reaction mixture was divided into three portions after 30 minutes of reaction time. One was aged at −10° C., one was aged at 25° C. with stirring, and another was aged and stirred at 60° C. A precipitate typically formed after adding Zn(OAc)₂.2H₂O powder to the alcohol-based (KOH/methanol) solution. The precipitate is white and may be visible or not visible depending on reagent purity and the reaction, itself. The precipitation typically dissolved within about five minutes to form a transparent ZnO colloidal solution. When the solution was observed by spectrofluorometry, two emission peaks were found, in agreement with that reported for ZnO quantum dots (data not shown). One of the emission peaks was a broad green luminescent band around 500 nm (2.35 eV); another was a ultraviolet emission band around 380 nm (3.25 eV). The diameter of the nanosized zinc oxide particles produced was determined to be around 3 nm. Of the three divided ZnO colloid portions, the portion that was stirred at 60° C. was turbid after 18 hours of reaction. The portion stirred at 25° C. remained transparent even after two weeks. The one that had been stored at −10° C. and was still transparent even after several months. Similar results were observed when using LiOH in place of KOH.

Upon preparation of a ZnO nanoparticle as described above, the surface of the ZnO nanoparticle may undergo one or more additional modifications to improve dispersion and prevent aggregation. Suitable modifications of the nanoparticle surface are known to one of ordinary skill in the art. After modification (when appropriate), ZnO nanoparticles are precipitated from the mixture by adding to the mixture a second organic compound containing a functional group that reacts or adsorbs with the ZnO nanoparticle surface (e.g., thiol group or a carboxylic group). ZnO nanoparticles are then typically recovered by centrifugation.

Modified or unmodified ZnO nanoparticles are then used to provide a stabilizer for a polymeric material as described further below.

In one embodiment, a stabilizer for polymers of the present invention includes one or more dispersed ZnO nanoparticles prepared as described above and having an average particle size of 15 nm or less that was combined as an additive with a polymeric material to provide a stabilized polymer composite. The average size range may be from 1 to 15 nanometers with a standard deviation of about 3 nanometers.

A polymeric material as described herein may include a monomer, polymer or copolymer composition. Monomers are those capable of forming a macromolecule by a chemical reaction. Suitable examples include a (meth)acrylic monomer (e.g., methyl methacrylate, methyl acrylate and butyl acrylate), a styrenic monomer (e.g., styrene, polystyrene, alpha-methyl styrene), and a pre-cure epoxy resin (e.g., bis-phenol A epoxy resin, bis-phenol F epoxy resin). Such monomers provide for polymers that include a (meth)acrylic resin containing more than 60% methyl methacrylate (e.g., polymethyl methacrylate), a styrenic resin containing more than 60% styrene (e.g., polystyrene) as well as various copolymer combinations, including methyl methacrylate-styrene copolymer, methyl methacrylate-methyl acrylate copolymer, methyl acrylate-butyl acrylate copolymer, styrene-methyl methacrylate copolymer, styrene-acrylonitrile copolymer, styrene-butadiene copolymer, styrene-ethylenebutylene copolymer and styrene-isobutylene copolymer.

A stabilizer of the present invention may react with a curing agent when desired. For example, a stabilizer further comprising an epoxy resin may be reacted further with a desired curing agent.

ZnO nanoparticles of the present invention are combined as an additive with a polymeric material to provide a stabilized polymer composite. Typically, a stabilizer of the present invention is prepared by dispersing ZnO nanoparticles into a desired monomer, polymer or copolymer, wherein the ZnO nanoparticles comprise at least about 0.05%-5.0% of the final composition. Examples of dispersing a ZnO nanoparticles into a desired monomer, polymer or copolymer are provided below.

A stabilizer for polymers of the present invention include ZnO nanoparticles in concentrated form, the stabilizer comprising ZnO nanoparticles from 1 % to 50% of the final stabilizer composition (i.e., stabilized polymer composite). In a concentrated form, the stabilizer is then combined as an additive with a polymeric material to provide a stabilized polymer composite in a less concentrated form. In one embodiment, the stabilizer in concentrated form includes ZnO nanoparticles that make up 20% or less of the final composition; however, more or less concentrated compositions may be formed. Any dilution process known to one of ordinary skill in the art may be used, such as mixing the stabilizer in a concentrated form with a desired monomer, polymer or copolymer with a mixer. A composition of the present invention may be formed by homogenously mixing ZnO nanoparticles and a desired monomer, polymer or copolymer. For example, when preparing in a concentrated form, the desired monomer, polymer or copolymer may be dissolved into a ZnO nanoparticle solution (e.g., sol-gel solution) and this mixture subsequently poured into a nonsolvent in order to precipitate ZnO nanoparticles and the desired monomer, polymer or copolymer concurrently. The precipitate may then provided to yet another desired monomer, polymer or copolymer as described herein. In some instances, the ZnO nanoparticles will comprise at least about 0.05%-5.0% of the final composition. Additional additives may also be provided, such as another stabilizer, polymer processing aid, filler, flame retardant, impact modifier, plasticizer, lubricant, UV absorber, pigment, glass fiber, as examples. When ZnO nanoparticles are dispersed in a monomer, the resulting composite may polymerize via polymerization methods known to one of ordinary skill in the art, such as emulsion polymerization, suspension polymerization, solution polymerization and bulk polymerization.

When ZnO nanoparticles are dispersed in a polymer, the resulting composite may also be molded with techniques known to one of ordinary skill in the art, including calender molding, extrusion, injection molding, as examples. Additional additives used in a molding, such as another stabilizer, polymer processing aid, filler, flame retardant, impact modifier, plasticizer, lubricant, UV absorber, pigment, glass fiber, as examples, may be included during molding and/or be blended with a stabilizer of the present invention, as needed. Examples of the present invention are herein provided. In the examples, the average particle size of ZnO nanoparticles in an alcohol based solution were calculated using an equation provided by Meulenkamp (see Meulenkamp E A, J. Phys. Chem. B 1998:102;5566-5572). The calculation converts the measured values of λ_{1/2} (the wavelength at which the absorption is the half of that at the shoulder) into particle sizes based on a size determination result from transmission electron microscopy (TEM) micrographs and XRD line broadening, in which: 1240/λ_{1/2}=a+b/D²−c/D, where a=3.301, b=294.0 and c=−1.09; λ_{1/2} is in nm, and D is diameter. The above equation was employed to calculate ZnO nanoparticles size from UV absorption measurements using a UV-vis spectrophotometer. Other suitable methods known to one of ordinary skill in the art may also be used to calculate average nanoparticle size.

Image analyses by TEM were used in which TEM images were recorded using a JEOL JEM-1200 EX instrument (80 kV). Heat-pressed samples were used by cutting samples into ultra thin sections for TEM observation. Typically, analysis via TEM comprised more than 200 particles in an image with a magnification of approximately 400,000.

The ZnO quantity in a sample was calculated based on Zn quantity as measured by elemental analysis. Elemental analysis of Zn quantity was conducted by digesting each sample using a microwave. Each sample weighed about 30 to 50 mg and was digested with about 10 mL of trace metal grade nitric acid. Digested samples were further analyzed by inductively coupled plasma-mass spectrometry.

A thermal decomposition temperature for each sample was measured by thermogravimetry using a sample weight of about 1 to 2 mg. The thermal decomposition temperature was regarded as the point at which 50% of the sample weight was reduced.

Example A. 79 g of 0.28% KOH in methanol was prepared and used as an alcohol-based solution. The solution was heated to 60° C. with stirring. 0.44 g (about 2 mmol) of zinc acetate dihydrate [Zn(OAc)₂.2H₂O] powder was then added to the alcohol-based solution under reflux and stirring. The molar ratio of zinc acetate dihydrate to KOH was about 1:2. After stirring continuously for about five hours, the final solution was cooled to about 23° C.; pH was 7.0 or higher with a final pH of 8.7. A UV absorption measurement of the final solution showed it to be a transparent sol comprising ZnO nanoparticles, also referred to herein as nanoparticles-10. The UV absorption wavelength (λ_{1/2}) was 338 nm. The average nanoparticles size of nanoparticles-10 was calculated to be 3 nm. A polymeric material comprising 5.5 g of 3.8% polymethyl methacrylate (PMMA; Mn=85,400) in methylethylketone was prepared at room temperature. To this solution, about 0.7 g of didodecyldimethylammonium bromide (DDAB) was added followed by the addition of about 6.0 g of nanoparticles-10. The molar ratio of DDAB to nanoparticles-10 was 10:1. While DDAB was added to this mixture, it is noted that DDAB or other additives (e.g., compatibilizers, dispersants) are not required to achieve good nanoscale dispersion of ZnO particles in the polymer matrix. The mixture was held at room temperature for about three hours, and then poured into 60 g of methanol. A precipitate was produced shortly thereafter; precipitation was allowed to continue for about three hours to complete the process. The precipitate was isolated by centrifugation and then dried at 60° C. for about five hours to provide for a powder (also referred to herein as stabilizer A). Assessment of stabilizer A by Fourier transform-infrared spectroscopy (FT-IR) confirmed that stabilizer A included PMMA and ZnO nanoparticles. Stabilizer A was subjected to elemental analysis and the amount of ZnO nanoparticles contained in stabilizer A was estimated to be about 2.5%.

1.0 g of stabilizer A in a powder form was provided as an additive to form a stabilized polymer composite. Stabilizer A included PMMA and ZnO nanoparticles in which ZnO nanoparticles were 2.5% of the final powder. Stabilizer A was mixed with 3.0 g of pure PMMA powder (Mn=85,400). The mixture was examined by elemental analysis and found to include ZnO nanoparticles as 0.5% of the mixture. The thermal decomposition temperature of the mixture was measured by thermogravimetry. A sample of the mixture was subjected to heat press at 180° C. and appearance of a molded sample was observed. The molded sample was also evaluated for average dispersed nanoparticle size and nanoparticle distribution (as standard deviation). The thermal decomposition temperature, nanoparticle appearance, average dispersed nanoparticle size, and standard deviation of nanoparticles are listed in the Table.

Example B. A composition in a powder form was obtained using a method similar to that described for Example A, except the powder was stabilizer B prepared without DDAB. Stabilizer B included PMMA and ZnO nanoparticles, as confirmed by FT-IR. Elemental analysis of stabilizer B indicated that ZnO nanoparticles were 2.5% of stabilizer B.

1.0 g of Stabilizer B in a powder form was provided as an additive to form a stabilized polymer composite. Stabilizer B included PMMA and ZnO nanoparticles in which ZnO nanoparticles were 2.0% of the composite. Stabilizer B was mixed with 2.0 g of pure PMMA powder (Mn=85,400). The mixture was examined by elemental analysis and found to include ZnO nanoparticles as 0.6% of the mixture. The thermal decomposition temperature of the mixture was measured by thermogravimetry. A sample of the mixture was subjected to heat press at 180° C. and appearance of a molded sample was observed. The sample was also evaluated for average dispersed nanoparticle size as well as nanoparticle distribution (as standard deviation). The thermal decomposition temperature, nanoparticle appearance, average dispersed nanoparticle size, and standard deviation of nanoparticles are listed in the Table.

Example C. A mixture of 5.5 g of 3.8% PMMA (Mn=85,400) in methylethylketone was prepared at room temperature as described in Example A. The mixture was then poured into 60 g of methanol to form a precipitate that was then recovered after about three hours by centrifugation. The precipitate was dried at 60° C. for about five hours to obtain a powder. The powder comprised PMMA, as confirmed by FT-IR. The thermal decomposition temperature of the powder was measured by thermogravimetry. A sample of the powder was subjected to heat press molding at 180° C. and appearance of a molded sample was observed. The thermal decomposition temperature and appearance of the molded sample are indicated in the Table.

Example D. Commercially available ZnO particles having an average reported particle size of 20 nm were added to methanol and then subjected to ultrasonic dispersion to provide for a dispersion of ZnO particles in methanol, herein referred to as dispersion-CD.

A polymeric material comprising 5.5 g of 3.8% PMMA (Mn=85,400) in methylethylketone was prepared at room temperature using a method similar to that described for Example D to which was added 6.0 g of dispersion-CD. The mixture was held at room temperature for three hours and then subjected to ultrasonic treatment and subsequently poured into 60 g of methanol to produce a precipitate. The precipitate was collected after about three hours by centrifugation followed by drying at 60° C. for about five hours to obtain a powder (also referred to herein as stabilizer C). Stabilizer C comprised PMMA and ZnO particles, as confirmed by FT-IR. Stabilizer C was subjected to elemental analysis and the amount of ZnO particles in the powder was estimated to be about 5.0%.

1.0 g of stabilizer C in a powder form was provided as an additive to form a stabilized polymer composite. Stabilizer C included PMMA and ZnO nanoparticles in which ZnO nanoparticles were 5.0% of the composite. Stabilizer C was mixed with 9.0 g of pure PMMA powder (Mn=85,400). The mixture was examined by elemental analysis and found to include ZnO nanoparticles as 0.5% of the mixture. The thermal decomposition temperature of the mixture was measured by thermogravimetry. A sample of the mixture was subjected to heat press molding at 180° C. and appearance of a molded sample was observed. The molded sample was also evaluated for average dispersed ZnO particle size as well as particle distribution (as standard deviation). The thermal decomposition temperature, molded appearance, average dispersed ZnO particle size, and standard deviation of ZnO particles are listed in the Table.

TABLE
Thermal decomposition temperature, appearance, average dispersed
size, and standard deviation for several representative examples.

| | | | Average | |
|---|---|---|---|---|
| | Thermal | | dispersed | Standard |
| | decomposition | | size | Deviation |
| | temperature (° C.) | Appearance | (nm) | (nm) |
| Example A | 372 | Clear | 6 | 1.6 |
| Example B | 372 | Clear | 6 | 1.6 |
| Example C | 331 | Clear | — | — |
| Example D | 356 | Opaque | >20 | >2.0 |

The Table illustrates the highly improved stability offered by stabilizers for polymeric materials of the present invention. Compositions of the present invention are provided as an additive to a polymeric material yielding a stabilized polymer composite. Importantly, stabilizers of the present invention provide both thermal stability and UV light stability to polymer composites. Such stabilizers serve as additives for preparing stabilized polymer composites.

What is claimed is:

1. A stabilizer composition comprising:
zinc oxide nanoparticles dispersed and having an average size of no more than about 15 nanometers, wherein the zinc oxide nanoparticles are provided as an additive to a polymeric material, thereby forming a stabilized polymer composite in which the zinc oxide nanoparticles remain dispersed and have an average size of no more than about 15 nanometers.

2. The stabilizer composition of claim 1, wherein the stabilized polymer composite is stabilized against heat and ultraviolet light.

3. The stabilizer composition of claim 1, wherein the zinc oxide nanoparticles are less than about 20% of the stabilized polymer composite.

4. The stabilizer composition of claim 1, wherein the polymeric material is a (meth)acrylic resin, a styrenic resin, a pre-cure epoxy resin, and combinations thereof.

5. The stabilizer composition of claim 1, wherein the zinc oxide nanoparticles are modified on their surface to reduce aggregation.

6. The stabilizer composition of claim 1, wherein the zinc oxide nanoparticles are about 2.5% of the stabilized polymer composite.

7. The stabilizer composition of claim 1, wherein the average size is three nanometers or less.

8. The stabilizer composition of claim 1, wherein stabilizer composition is an additive.

9. The stabilizer composition of claim 1, wherein the stabilizer composition further comprises a second additive selected from the group consisting of dispersant, thermal stabilizer, polymer processing aid, flame retardant, impact modifier, plasticizer, UV absorber, pigment, glass fiber, curing agent, lubricant, and combinations thereof.

10. A stabilizer composition comprising:
zinc oxide nanoparticles, dispersed and having an average size of no more than about 15 nanometers, wherein the metal oxide is formed from a zinc oxide precursor; and
a polymeric material comprising a (meth)acrylic resin, a styrenic resin, a pre-cure epoxy resin, and combinations thereof, combined with the zinc oxide nanoparticles to form a stabilized polymer composite, wherein the zinc oxide nanoparticles remain dispersed and have an average size of no more than about 15 nanometers.

11. The stabilizer composition of claim 10, wherein the stabilizer composition is an additive.

12. The stabilizer composition of claim 11, wherein the additive is a stabilizer against heat and ultraviolet light.

13. The stabilizer composition of claim 10, wherein the zinc oxide nanoparticles are modified on their surface to reduce aggregation.

14. The stabilizer composition of claim 10, wherein the stabilizer composition further comprises a second additive selected from the group consisting of dispersant, thermal stabilizer, polymer processing aid, flame retardant, impact modifier, plasticizer, UV absorber, pigment, glass fiber, curing agent, lubricant, and combinations thereof.

15. The stabilizer composition of claim 10, wherein the zinc oxide nanoparticles are less than about 20% of the stabilized polymer composite.

16. A method of providing a stabilizer composition comprising the steps of:
dispersing zinc oxide nanoparticles having an average size of no more than about 15 nanometers in a polymeric material comprising (meth)acrylic resin, a styrenic resin, a pre-cure epoxy resin, and combinations thereof, thereby forming a stabilized polymer composite, wherein the zinc oxide nanoparticles remain dispersed and have an average size of no more than about 15 nanometers.

17. The method of claim 16, wherein the zinc oxide nanoparticles are modified on their surface to reduce aggregation.

18. The method of claim 16, wherein the average size is three nanometers or less.

19. The method of claim 16, wherein the method further comprises adding an additive selected from the group consisting of dispersant, thermal stabilizer, polymer processing aid, flame retardant, impact modifier, plasticizer, UV absorber, pigment, glass fiber, curing agent, lubricant, and combinations thereof.

20. The method of claim 16, wherein zinc oxide nanoparticles are less than about 20% of the stabilized polymer composite.
